(19) United States
(12) Patent Application Publication
(10) Pub. No.: US 2019/0127496 A1
(43) Pub. Date: May 2, 2019

(54) CONTINUOUS TUNING OF Cl:Mg RATIO IN A SOLUTION POLYMERIZATION

(71) Applicant: NOVA Chemicals (International) S.A., Fribourg (CH)

(72) Inventors: Stephen Brown, Calgary (CA); Lawrence VanAsseldonk, Sarnia (CA); Stuart Nield, Bright's Grove (CA); Donald Hartlen, Bright's Grove (CA); Roy Mauti, Bright's Grove (CA)

(73) Assignee: NOVA Chemicals (International) S.A., Fribourg (CH)

(21) Appl. No.: 16/137,867

(22) Filed: Sep. 21, 2018

(30) Foreign Application Priority Data
Sep. 1, 2017 (CA) 2978205

(51) Int. Cl. C08F 4/642; C08F 210/16; C08F 2/04; G05D 11/02; G05B 1/00

(52) U.S. Cl. CPC C08F 4/6425; C08F 210/16; C08F 2400/02; G05D 11/02; G05B 1/00; C08F 2/04

(57) ABSTRACT

The activity of an in situ prepared Ziegler Natta catalyst in a solution polymerization may be tuned on a continuous basis by monitoring the catalyst activity (conversions) and on a frequent periodic basis incrementally adjusting the alkyl halide in the catalyst to optimize the activity.

The present disclosure relates to a process to optimize the ratio of chloride ions to magnesium in a solution polymerization of ethylene using a Ziegler Natta catalyst. Ziegler Natta catalysts for the solution polymerization of ethylene may be prepared in several ways. In one method the catalyst is prepared “off-line”. Off-line catalysts are fully prepared in a separate reactor and the final catalyst is fed to the polymerization reactor. This provides the ability to control the catalyst composition prior to being fed to the polymerization reactor. On-line catalysts are prepared in a pre-reactor up-stream of or in some cases in-line with the feed to the reactor. When a cylinder containing one or more components for the catalyst and, for example, alkyl halide or the magnesium compounds is changed there is a very short time to correct any deficiencies in the catalyst formulation. In some embodiments this disclosure seeks to provide an on line method to optimize the ratio of Cl:Mg in a Ziegler Natta catalysts used in the solution polymerization of ethylene.

U.S. Pat. No. 4,250,288 issued Feb. 10, 1981 to Lowery et al., assigned to The Dow Chemical Company teaches an off-line catalyst. Once the prepared catalyst is added to the reactor there are no changes to the catalyst formulation.

U.S. Pat. No. 4,547,475 issued Oct. 15, 1985 to Glass et al., assigned to The Dow Chemical Company also appears to teach an off-line catalyst.

U.S. Pat. No. 6,339,036 issued Jan. 15, 2002 to Jaber, assigned to NOVA Chemicals (International) S.A. teaches a catalyst for a solution polymerization process which can be made using an in-line method (col. 5 lines 20-25). The patent is silent on any method to optimize the halide (chloride) to magnesium ratio in the catalyst during the polymerization reaction.

In other embodiments this disclosure seeks to provide to optimize the ratio of halide (chloride) to magnesium in a solution Ziegler Natta catalyst during polymerization.

Provided herein is a solution phase polymerization of ethylene and one or more C₄₋₈ alpha olefins wherein the catalyst is prepared by mixing in an inert hydrocarbon in a first catalyst preparation reactor immediately upstream from the polymerization reactor

i) a titanium compound of the formula:
Ti((O)ₐR¹)_{b}X_{c} wherein R¹ is chosen from C₁₋₄ alkyl radicals, C₆₋₁₀ aromatic radicals and mixtures thereof, X is chosen from a chlorine atom and a bromine atom, a is 0 or 1, b is 0 or an integer up to 4 and c is 0 or an integer up to 4 and the sum of b+c is the valence of the Ti atom;

ii) a first aluminum compound of the formula Al¹R²_{d}X_{3-d} wherein each R² is independently selected from alkyl groups having 1-10 carbon atoms, and X is a halogen atom;

iii) a magnesium compound of the formula Mg(R³)₂ in which each R³ is independently selected from alkyl groups having 1-10 carbon atoms;

iv) an alkyl chloride of the formula R⁴Cl where R⁴ is chosen from straight or branched C₁₋₁₀ alkyl radicals and C₆₋₁₀ aromatic radicals; and

v) an aluminum compound of the formula (R⁵)ₑAl² (OR⁶)₃₋ₑ wherein each R⁵ and R⁶ is independently chosen from C₁₋₁₀ alkyl radicals to provide a molar ratio of Mg:Ti from 4:1 to 10:1; a molar ratio of Al¹:Ti from 0.00:1 to 1.5:1; a molar ratio of alkyl halide to magnesium from 1.7:1 to 2.5:1; and a molar ratio of Al² to titanium from 1:1 to 4:1

and monitoring the ratio of reactive chloride to magnesium by its impact on the polymerization reaction by:
a) monitoring the activity or conversion for a period of time of not less than 5 minutes to establish a base line;
b) determining if the standard deviation of the activity base-line is less than 1% of the average value;
c) if the standard deviation of the baseline is above 1%, wait an additional 5 minutes and repeat steps a) and b) to obtain an activity baseline having a standard deviation less than 1%;
d) increase the molar ratio of chloride to magnesium by 0.02 by adding more alkyl chloride to the catalyst preparation reactor;
e) monitor the activity at the new molar ratio of chloride to magnesium ratio not less than 5 minutes;
f) if a decrease in activity is seen at the new value, return to the preceding value of the chloride to magnesium ratio and then decrease the chloride to magnesium ratio in steps of 0.02 by adding less alkyl chloride to the catalyst preparation reactor at each step monitor the activity for not less than 5 minutes until a decrease in activity is seen at which point return to the preceding value (the immediately preceding value);
g) if an increase in activity is seen in step e), make a further increase in the molar ratio of chloride to magnesium in steps of 0.02 by adding more alkyl chloride to the catalyst preparation reactor monitor the activity at the new molar ratio of chloride to magnesium ratio for not less than 5 minutes;
h) continue to increase the molar ratio of chloride to magnesium in steps of 0.02 by adding more alkyl chloride to the catalyst preparation reactor, at each step monitor the activity at the new molar ratio of halide to magnesium ratio for not less than 5 minutes if a decrease in activity is seen at the new value, return to the preceding value (the immediately preceding) of the halide to magnesium ratio; and
i) if during any step time the standard deviation in the monitored activity is greater than 1% of the average value, wait an additional 5 minutes.

In a further embodiment, the readings continue to be taken on a basis of between 5 and 15 minutes after the molar ratio of chloride to magnesium has been optimized.

In a further embodiment of any preceding embodiment, the catalyst activity is determined by one or more of the reactor temperature, ethylene or comonomer conversion or amount of polymer produced.

In a further embodiment of any preceding embodiment, the titanium compound is titanium tetrachloride.

In a further embodiment of any preceding embodiment, the first aluminum compound is triethyl aluminum.

In a further embodiment of any preceding embodiment, the magnesium compound is chosen from butyl ethyl magnesium, diethyl magnesium and dibutyl magnesium.

In a further embodiment of any preceding embodiment, the reactive halide is t-butyl chloride.

In a further embodiment of any preceding embodiment, the second aluminum compound is diethyl aluminum ethoxide.

In a further embodiment of any preceding embodiment, the standard deviation of the base line is less than 0.30.

In a further embodiment of any preceding embodiment, the ethylene conversion is determined by a heat and mass balance calculation.

In a further embodiment of any preceding embodiment, the ethylene conversion is determined by a near infrared spectrometer located proximate to the outlet of the polymerization reactor.

In a further embodiment of any preceding embodiment, the calculations are done using a computer.

### BRIEF DESCRIPTION OF THE DRAWING

FIG. 1 is a plot of the mean reaction temperature against the ratio of chloride to magnesium at various concentration of alkyl halide in the polymerization reactor.

The catalysts of the present disclosure are formed by the mixing of a number of components in a relatively small pre-reactor (relative to the size/volume of the polymerization reactor) up-stream or on-stream to a feed into the polymerization reactor. The catalyst comprises a mixture of a titanium compound, optionally with a vanadium oxide (VOCl₃), a first aluminum compound, a magnesium compound, an alkyl chloride, and a second aluminum compound.

The titanium compound is of the formula:

Ti((O)ₐR¹)_{b}X_{c} wherein R¹ is chosen from C₁₋₆ alkyl radicals, C₆₋₁₀ aromatic radicals and mixtures thereof, X is chosen from a chlorine atom and a bromine atom, for example, a chlorine atom, a is 0 or 1, b is 0 or an integer up to 4 and c is 0 or an integer up to 4 and the sum of b+c is the valence of the Ti atom. In some embodiments R¹ if present is a C₁₋₆, for example, C₁₋₄ alkyl radical. In some embodiments the titanium compound maybe a titanium alkoxide for example where b is at least one and at least one a is 1, and c is a number of 3 or less. In some embodiments b is 4 and all a's are 1. (Ti (OEt)₄). A relatively inexpensive titanium compound which may be used in the various embodiments disclosed herein is TiCl₄.

The first aluminum compound may be of the formula

Al¹R²_{d}X_{3-d} wherein each R² is independently selected from alkyl groups having 1-10 carbon atoms, and X is a halogen atom, for example, a chlorine atom. In some embodiments R² is an alkyl radical having from 1 to 4 carbon atoms. In some embodiments d is 3 and there are no halogen substituents in the first aluminum compound. One useful first aluminum component is tri-ethyl aluminum.

The magnesium compound is of the formula Mg(R³)₂ in which each R³ is independently selected from alkyl groups having 1-10 carbon atoms. In some embodiments R³ is selected from a C₁₋₄ alkyl radical. In some embodiments the magnesium compound may be selected for the group consisting of diethyl magnesium, dibutyl magnesium and ethyl butyl magnesium and mixtures thereof.

The halide (chloride) may be C₁₋₁₀ alkyl halide (chloride) in which the halide will react with the magnesium compound. The alkyl group may be branched or straight chained. One useful halide is t-butyl chloride.

The second aluminum compound may have the formula (R⁵)ₑAl² (OR⁶)₃₋ₑ wherein each R⁵ and R⁶ is independently chosen from

C₁₋₁₀ alkyl radicals and e is an integer from 1 to 3. In some embodiments R⁵ and R⁶ are selected from C₁₋₄ alkyl radicals, for example, straight chain alkyl radicals. In some embodiments e is 2. A suitable second aluminum compound is diethyl aluminum ethoxide.

The components are mixed to provide a molar ratio of Mg:Ti from 4:1 to 10:1; a molar ratio of Al¹:Ti from 0.00:1 to 1.5:1; a molar ratio of alkyl halide to magnesium from 1.7:1 to 2.5:1; and a molar ratio of Al² to titanium from 1:1 to 4:1. In some embodiments the molar ratio of Mg:Ti may be from 4:1 to 5.5:1, for example, from 4.3:1 to 5.0:1. In some embodiments the molar ratio of alkyl halide to magnesium may range from 1.7:1 to 2.3:1. In some embodiments the second aluminum compound is an alkyl aluminum alkoxide and the molar ratio of alkyl aluminum alkoxide to titanium is from 1.2:1 to 2:1, for example, from 1.2:1 to 1.8:1.

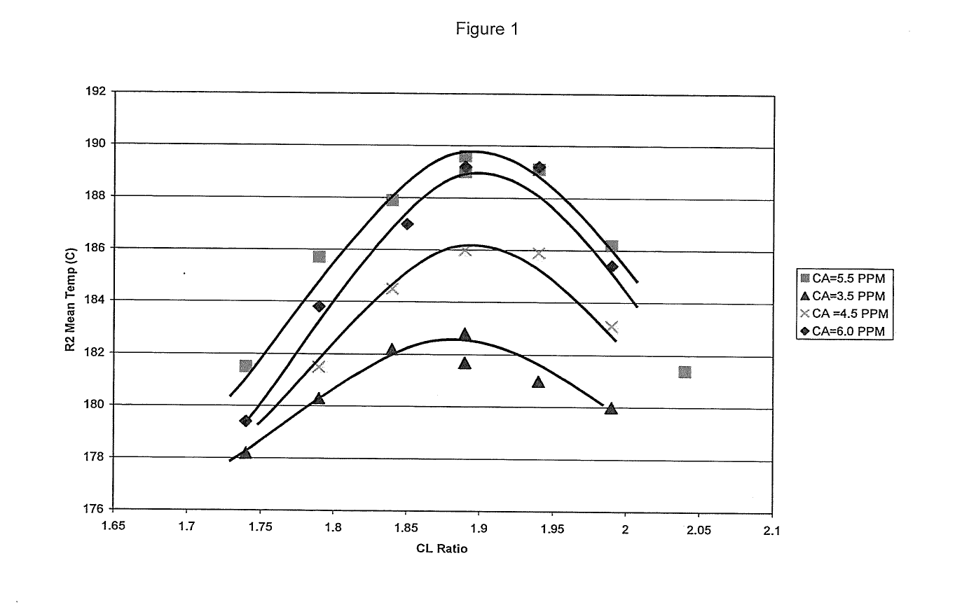

The resulting catalyst activity/productivity is sensitive to the ratio of chlorine to magnesium. FIG. 1 is a plot of the effect on reaction temperature (conversion in an adiabatic reactor) of the ratio of Cl to Mg in the catalyst at a fixed level of titanium tetrachloride in the catalyst. The plot shows that the mean reaction temperature (conversion in an adiabatic reactor) at different ratios of alkyl halide to magnesium at a fixed titanium tetrachloride level in the catalyst goes through a maximum and then declines. The optimum ratio of chloride to magnesium may be determined by the following steps:
a) monitoring activity (or conversion) of the catalyst for a period of time of not less than 5 minutes to establish a base line;
b) determining if the standard deviation of the activity base line is less than 1% of the average value;
c) if the standard deviation of the baseline is above 1%, wait an additional 5 minutes and repeat steps a) and b) to obtain an activity baseline having a standard deviation less than 1%;
d) increase the molar ratio of chloride to magnesium by 0.02 by adding more alkyl chloride to the catalyst preparation reactor;
e) monitor the activity at the new molar ratio of chloride to magnesium ratio for not less than 5 minutes;
f) if a decrease in activity is seen at the new value, return to the preceding value of the chloride to magnesium ratio and then decrease the chloride to magnesium ratio in steps of 0.02 by adding less alkyl chloride to the catalyst preparation reactor at each step monitor the activity for not less than 5 minutes until a decrease in activity is seen at which point return to the preceding value;
g) if an increase in activity is seen in step e) make a further increases in the molar ratio of chloride to magnesium in steps of 0.02 by adding more alkyl chloride to the catalyst preparation reactor monitor the reactivity at the new molar ratio of chloride to magnesium ratio for not less than 5 minutes;
h) continue to increase the molar ratio of chloride to magnesium in steps of 0.02 by adding more alkyl chloride to the catalyst preparation reactor, at each step monitor the activity at the new molar ratio of halide to magnesium ratio for not less than 5 minutes if a decrease in activity is seen at the new value, return to the preceding value of the halide to magnesium ratio; and
i) if during any step time the standard deviation in the monitored activity is greater than 1% of the average value wait an additional 5 minutes.

In some embodiments, the standard deviation of the base line may be less than 0.30.

The readings may continue to be taken on a basis of between 5 and 15 minutes after the molar ratio of chloride to magnesium has been optimized to monitor any further variation in ratio of chlorine to magnesium compound.

The catalyst activity or conversion is determined by one or more of the polymerization reactor temperature, ethylene or comonomer conversion or amount of polymer produced. In some embodiments the catalyst activity is determined only by the temperature of the polymerization reactor. In other embodiments the monomer or comonomer conversion is measured using near infrared spectroscopy at a location proximate to the outlet of the polymerization reactor.

In some embodiments the calculations are done using a computer program which is part of the reactor control system.

What is claimed is:

1. In a solution phase polymerization of ethylene and one or more C₄₋₈ alpha olefins wherein the catalyst is prepared by mixing in an inert hydrocarbon in a first catalyst preparation reactor immediately upstream from the polymerization reactor
i) a titanium compound of the formula:
Ti((O)ₐR¹)_{b}X_{c} wherein R¹ is chosen from C₁₋₄ alkyl radicals, C₆₋₁₀ aromatic radicals and mixtures thereof, X is chosen from a chlorine atom and a bromine atom, a is 0 or 1, b is 0 or an integer up to 4 and c is 0 or an integer up to 4 and the sum of b+c is the valence of the Ti atom;
ii) a first aluminum compound of the formula Al¹R²_{d}X_{3-d} wherein each R² is independently selected from alkyl groups having 1-10 carbon atoms, and X is a halogen atom;
iii) a magnesium compound of the formula Mg(R³)₂ in which each R³ is independently selected from alkyl groups having 1-10 carbon atoms;
iv) an alkyl chloride of the formula R⁴Cl where R⁴ is chosen from straight or branched C₁₋₁₀ alkyl radicals and C₆₋₁₀ aromatic radicals; and
v) an aluminum compound of the formula (R⁵)ₑAl² (OR⁶)₃₋ₑ wherein each R⁵ and R⁶ is independently chosen from C₁₋₁₀ alkyl radicals and e is an integer from 1 to 3, to provide a molar ratio of Mg:Ti from 4:1 to 10:1; a molar ratio of Al¹:Ti from 0.00:1 to 1.5:1; a molar ratio (for example 0.05 at PE2 now) of alkyl halide to Mg from 1.7:1 to 2.5:1; and a molar ratio of Al² to titanium from 1:1 to 4:1,
and monitoring the ratio of reactive chloride to magnesium by its impact on the polymerization reaction by:
j) monitoring the activity of the catalyst for a period of time of not less than 5 minutes to establish a base line;
k) determining if the standard deviation of the reactivity base line is less than 1% of the average value;
l) if the standard deviation of the baseline is above 1% wait an additional 5 minutes and repeat steps a) and b) to obtain an activity baseline having a standard deviation less than 1%;
m) increase the molar ratio of chloride to magnesium by 0.02 by adding more alkyl chloride to the catalyst preparation reactor;
n) monitor the reactivity at the new molar ratio of chloride to magnesium ratio not less than 5 minutes;
o) if a decrease in reactivity is seen at the new value, return to the preceding value of the chloride to magnesium ratio and then decrease the chloride to magnesium ratio in steps of 0.02 by adding less alkyl chloride to the catalyst preparation reactor at each step monitor the reactivity for not less than 5 minutes until a decrease in activity is seen at which point return to the preceding value;
p) if an increase in reactivity is seen in step e) make a further increases in the molar ratio of chloride to magnesium in steps of 0.02 by adding more alkyl chloride to the catalyst preparation reactor monitor the reactivity at the new molar ratio of chloride to magnesium ratio for not less than 5 minutes;
q) continue to increase the molar ratio of chloride to magnesium in steps of 0.02 by adding more alkyl chloride to the catalyst preparation reactor, at each step monitor the reactivity at the new molar ratio of halide to magnesium ratio for not less than 5 minutes. If until a decrease in reactivity is seen at the new value, return to the preceding value of the halide to magnesium ratio; and
r) if during any step time the standard deviation in the monitored reactivity is greater than 1% of the average value wait and additional 5 minutes.

2. The process according to claim 1, wherein the readings continue to be taken on a basis of between 5 and 15 minutes after the molar ratio of chloride to magnesium has been optimized.

3. The process according to claim 1, where the catalyst reactivity is determined by one or more of the reactor temperature, ethylene or comonomer conversion or amount of polymer produced.

4. The process according to claim 1, wherein the titanium compound is titanium, tetrachloride.

5. The process according to claim 4, wherein the first aluminum compound is triethyl aluminum.

6. The process according to claim 5, wherein the magnesium compound is chosen from butyl ethyl magnesium, dibutyl magnesium and diethyl magnesium.

7. The process according to claim 6, wherein the reactive halide is t-butyl chloride.

8. The process according to claim 7, wherein the second aluminum compound is diethyl aluminum ethoxide.

9. The method according to claim 8, wherein the standard deviation of the base line is less than 0.30.

10. The method according to claim 1, wherein the ethylene conversion is determined by a heat and mass balance calculation.

11. The method according to claim 1, where in the ethylene conversion is determined by a near infrared spectrometer located proximate to the outlet of the polymerization reactor.

12. The method accord to claim 10, wherein the calculations are done using a computer.

13. The method accord to claim 11, wherein the calculations are done using a computer.
